(19) United States
(12) Patent Application Publication
(10) Pub. No.: US 2016/0186032 A1
(43) Pub. Date: Jun. 30, 2016

(54) DRILLING FLUID COMPOSITION AND METHOD USEFUL FOR REDUCING ACCRETION OF BITUMIN ON DRILL COMPONENTS

(71) Applicant: DOW GLOBAL TECHNOLOGIES LLC, Midland, MI (US)

(72) Inventors: Wanglin Yu, Pearland, TX (US); Harpreet Singh, Pearland, TX (US)

(21) Appl. No.: 14/907,359

(22) PCT Filed: Sep. 23, 2014
(86) PCT No.: PCT/US2014/056940

§ 371 Date: Jan. 25, 2016

Related U.S. Application Data
(60) Provisional application No. 61/882,666, filed on Sep. 26, 2013.

(51) Int. Cl. C09K 8/035; E21B 37/06; E21B 21/00; C09K 8/06; C09K 8/524

(52) U.S. Cl. CPC C09K 8/035; C09K 8/06; C09K 8/524; E21B 21/00; E21B 37/06

(57) ABSTRACT

Disclosed is an anti-accretion additive for aqueous drilling fluids and methods to use thereof. The anti-accretion additive reduces bitumen and/or heavy oil materials from sticking to metal surfaces such as drill bits, drillstring, casing, and the like. Specifically, the anti-accretion additive comprises from 5 to 50 parts by weight of a propoxylated alcohol and from 95 to 50 parts by weight of a propoxylated and ethoxylated alcohol.

### FIELD OF THE INVENTION

The present invention relates to fluids used for drilling and completing oil wells and in particular those useful for deterring accretion of tar/bitumen on metal surfaces.

### BACKGROUND OF THE INVENTION

The process of drilling a hole in the ground for the extraction of a natural resource requires a fluid for removing cuttings from the wellbore, controlling formation pressures and maintaining hole stability. Drilling through oil sand formations causes problematic accretion of tar on drilling apparatus. Bitumen accretion on metal surfaces impairs drilling operations by blinding shale shaker screens, plugging centrifuges and drill bits, torque and drag increase and stuck pipe or casing. Standard drilling practices through oil sand formations, which are generally unconsolidated, can also lead to hole instability problems.

Additives, such as solvents, surfactants and viscosifiers, have been used in drilling fluids for drilling through bitumen containing formations. In addition, or alternately, drilling fluids have been chilled to deter accretion and enhance hole stability. However, these prior art additives and/or processes for reducing bitumen accretion suffer from one or more disadvantage or inefficiency. An effective additive for cleaning and inhibiting the accretion of bitumen and other fluids or solids in and on drilling equipment is desirable, in particular one demonstrating good biodegradability and low aquatic toxicity.

### SUMMARY OF THE INVENTION

The present invention is such an ati-accretion additive. In one embodiment, the present invention is an anti-accretion additive comprising:
i from 5 to 50 parts by weight of a propoxylated alcohol of the formula:

RO—(PO)ₓ
wherein
R is a linear or branched alkyl having from 8 to 16 carbons, preferably 8 to 10 carbons, more preferably independently 2-ethylhexyl or 2-propylheptyl,
and
x is from 1 to 10, preferably 3 to 7, more preferably 5
and
ii from 95 to 50 parts by weight of a propoxylated and ethoxylated alcohol of the formula:

R¹O—(PO)_{y}-(EO)_{z},
wherein
R¹ is a linear or branched alkyl having from 8 to 16 carbons, preferably 8 to 10 carbons, more preferably independently 2-ethylhexyl or 2-propylheptyl,
y is from 2 to 10, preferably 3 to 7, and more preferably 5
and
z is from 3 to 20, preferably 5 to 10
wherein parts by weight is based on the combined weight of the propoxylated alcohol i and a propoxylated and ethoxylated alcohol ii and EO and PO denote ethylene oxide and propylene oxide units, respectively.

Another embodiment of the present invention is an aqueous-based drilling fluid comprising the anti-accretion additive disclosed herein above, preferably comprising one or more of a viscosifier, fluid loss additive, a lubricant, a foam control agent, a weighting material, a salt, or a surfactant.

Another embodiment of the present invention is a method for drilling a wellbore through a formation comprising the steps of:
a operating a drilling assembly to drill a wellbore;
and
b circulating an aqueous-based drilling fluid through the wellbore as it is drilled, the aqueous-based drilling fluid comprising the anti-accretion additive disclosed herein above.

Another embodiment of the present invention is a method for limiting accretion on metal surfaces in contact with tar-sand containing formation, the method comprising the step of washing the metal surfaces with an aqueous-based drilling fluid comprising an anti-asccretion additive disclosed herein above.

Another embodiment of the present invention is a method for removing accretion from metal surfaces in contact with tar sand-containing formation comprising the step of washing the metal surfaces with an aqueous-based drilling fluid comprising an anti-asccretion additive disclosed herein above.

### A BRIEF DESCRIPTION OF THE DRAWINGS

FIGS. 1 to 4 are photographs showing the results of tests for bitumen accretion on metal surfaces.

FIG. 5 is a photograph showing the results of wash-out from tar sands by different antil-accretion additives.

### DETAILED DESCRIPTION OF THE INVENTION

An anti-accretion additive, an aqueous-based drilling fluid, and a method for drilling a wellbore has been invented for use in formations bearing heavy oil, also called bitumen or tar. The accretion additive, drilling fluid, and method are useful to limit and possibly remove tar accretion on metal surfaces and/or to maintain borehole stability, may comprise standard viscosifiers and other chemicals used in drilling fluids. The drilling fluid and method may therefore be environmentally responsible and economically viable. We have found that a mixture comprising a propoxylated alcohol and a propoxylated and ethoxylated alcohol is a suprisingly effective anti-accretion additive. Propoxylated alcohols and propoxylated and ethoxylayted alcohols are known, for example see U.S. Pat. No. 5,705,476.

Suitable propoxylated alcohols useful in the anti-accretion additive of the present invention have the formula:

RO—(PO)ₓ—H I
wherein R is preferably a linear or branched alkyl having from 8 to 16 carbons, preferably 8 to 10 carbons, and more preferably 2-ethylhexyl or 2-propylheptyl;
x is an integer from 1 to 10, preferably 3 to 7, and more preferably 5;
and
PO denotes a propylene oxide unit.

Suiatable propoxylated and ethoxylated alcohols useful in the anti-accretion additive of the present invention have the formula:

R¹O—(PO)_{y}-(EO)_{z}—H, II
wherein R¹ is a linear or branched alkyl having from 8 to 16 carbons, preferably 8 to 10 carbons, and more preferably 2-thylhexyl or 2-propylheptyl;
y is from 2 to 10, preferably 3 to 7, and more preferably 5;
z is from 3 to 20, preferably 5 to 10;
and
EO and PO denote ethylene oxide and propylene oxide units, respectively.

Preferably the propoxylated alcohol I is present in an amount of from 5 to 50 parts by weight and the propoxylated and ethoxylated alcohol II is present in an amount of from 95 to 50 parts by weight, parts by weight are based on the combined weight of the propoxylated alcohol I and a propoxylated and ethoxylated alcohol II. More preferably the propoxylated alcohol I is present in an amount of from 10 to 30 parts by weight and the propoxylated and ethoxylated alcohol II is present in an amount of from 90 to 70 parts by weight, parts by weight are based on the combined weight of the propoxylated alcohol I and a propoxylated and ethoxylated alcohol II.

One embodiment of the present invention is an aqueous-based drilling fluid comprising the anti-accretion additives described herein above. In a preferred embodiment, the aqueous liquid is water, typically fresh water, but alternatively brine water or formation water (i.e., water naturally occurring in a formation through which a well is being drilled).

Preferably, the anti-accretion additive is present in the aqueous-based drilling fluid in an amount of equal to or greater than 0.01 weight percent, and more preferably in an amount of equal to or greater than 0.1 weight percent, weight percent based on the total weight of the aqueous drilling fluid. Preferably, the anti-accretion additive is present in the aqueous-based drilling fluid in an amount of equal to or less than 10 weight percent, and more preferably in an amount of equal to less than 1 weight percent, weight percent based on the total weight of the aqueous drilling fluid.

Another embodiment of the present invention is an aqueous-based drilling fluid comprising the anti-accretion additives described herein above and a viscosifier. Viscosifiers provide carrying capacity to an aqueous-based drilling fluid. Viscosifiers, for example, increase the viscosity of drilling fluid so that it can carry cuttings along with the flow of drilling fluid and to suspend cuttings and weight materials during periods of noncirculation. Viscosifiers may also act to reduce fluid loss by inhibiting fluid infiltration to the formation. Viscosifiers may prevent deposition or re-deposition of the bitumen on metal surfaces by suspending the tar and tar sand particles in the fluid. Some common viscosifiers useful in embodiments of the present drilling fluid may include, for example, any of: clay, xanthan gum, wellan gum, schleroglucan, guar gum, natural organic polymers, synthetic polymers, HEC (hydroxyethylcellulose), PAC (polyanionic cellulose), polyacrylates, ethylene oxide polymers, or mixtures thereof.

In one embodiment of the present invention, an aqueous-based drilling fluid may comprise a viscoifier in an amount of from 0.1 to 10 percent by weight based on the total weight of the aqueous-based drilling fluid.
The aqueous-based drilling fluid of the present invention may also comprise one or more additional drilling fluid additives used in such compositions, for example one or more of a fluid loss additive, a lubricant, a foam control agent, a weighting material, a salt, or a surfactant. These additional additives may be added to the drilling fluid when the fluid is prepared, directly into the tanks and may alternately or in addition by added by application first to metal surfaces such as shale shakers, etc. at surface to thereby enter the drilling fluid stream.

An aqueous-based drilling fluid according to the present invention may also include, if desired, a lubricant. The lubricant may act to soften the tar and provide a lubricating action to assist drilling and running liners into long horizontal sections of a wellbore. The lubricant may be non-ionic. High flash point vegetable oils, such as those having a flash point greater than 148° C., may be of some use in the present drilling fluids. Useful lubricants may include, for example, fatty acid methyl esters for example with an HLB (hydrophile-lipophile balance) of about 6, such as are commonly available as soybean oil, for example, commercially available as SoyClear™ products by AG Environmental Products, LLC or Oleocal™ products by Lambent Technologies Corp., or canola oil, diesel oil, long chain alcohols, mineral oils, and mixtures thereof.

In one embodiment of the present invention, an aqueous-based drilling fluid may comprise a lubricant in an amount of from 0.5-15 percent by weight lubricant based on the total weight of the aqueous-based drilling fluid.

Fluid loss additives may also be used in an aqueous-based drilling fluid in order to help prevent the drilling fluid from invading into porous subterranean formations under the actin of temperature and pressure. Some common fluid loss additives include, for example, starches, PAC, CMC (modified carboxy methyl cellulose), or mixtures of these compounds. Some of these chemicals may also have a viscosifying function.

In one embodiment of the present invention, an aqueous-based drilling fluid may comprise a fluid loss additive in an amount of from 0.1 to 10 percent by weight based on the total weight of the aqueous-based drilling fluid.

The drilling fluid may contain various foam control agents such as alcohol-based and silicone-based defoamers of the types known in the field of the invention.

In one embodiment of the present invention, an aqueous-based drilling fluid may comprise a foam control agent in an amount of from 0.01 to 5 percent by weight based on the total weight of the aqueous-based drilling fluid.

The drilling fluid may contain various weighting material in order to increase the density of the drilling fluid. Generally, weighting materials are inert, high density particulate solid materials. Examples of weighting materials include, but not limited to, barite, hematite, iron oxide, magnesium carbonate, calcium carbonate, or combinations of these compounds.

In one embodiment of the present invention, an aqueous-based drilling fluid may comprise a weighting material in an amount of from 0.5 to 20 percent by weight based on the total weight of the aqueous-based drilling fluid.

The drilling fluid may contain various bridging agents in order to seal off the pores of subterranean formations that are contacted by drilling fluids. These agents are characterized by particle size distribution which can sufficiently seal the subterranean pores. Examples of bridging agents include, but are not limited to, calcium carbonate, polymers, fibrous materials, hydrocarbon based materials, or combinations of these compounds.

In one embodiment of the present invention, an aqueous-based drilling fluid may comprise a bridging agent in an amount of from 0.5 to 15 percent by weight based on the total weight of the aqueous-based drilling fluid.

Another embodiment of the present invention, an aqueous-based drilling fluid may comprise a salt. The additions of a salt may enhance the ability of the viscosifier to fully hydrate and provide greater viscosity. Examples of salts that may be used in the aqueous-based drilling fluid of the present invention include, but re not limited to, potassium sulfate, ammonium sulfate, calcium chloride, potassium acetate, potassium chloride, por mixtures thereof.

If a salt is included in the aqueous-based drilling fluid of the present invention, it should be in an amount of greater than zero but equal to or less than 20 percent by volume.

In one embodiment of the present invention the aqueous-base drilling fluid comprises a surfactant which primarily serves to assist in dispersing clay and other solid particles in the fluid without creating environmental or disposal problems. Accordingly, surfactants used in the present aqueous-based drilling fluids are substantially any nontoxic, water-soluble agent suitable for use in aqueous-based drilling fluids that are compatible with the other components and act to disperse solids in the fluid. Suitable surfactants include, but are not limited to, alcohol ethoxylates, alcohol alkoxylates, alkylphenon ethoxylates, alkylphenon alkoxylated, alkylamine ethoxylates, alkylamine alkoxylates, alkylpolyglusides, alkylbenzene sulfonates, alkylether sulfates, alkylnaphthalene sulfonates, lignosulfonates, alphaolefin sulfonates, and the like.

In one embodiment of the present invention, an aqueous-based drilling fluid may comprise a surfactant in an amount of from 0.01 to 10 percent by weight based on the total weight of the aqueous-based drilling fluid.

The accretion additive and aqueous-based drilling fluid comprising said accretion additive are useful to inhibit tar accretion on metal surfaces. In one aspect the accretion additive and aqueous-based drilling fluids comprising said accretion additive can be used in a method for drilling a wellbore through an oil sand containing formation. In such a method, without the present accretion additive, tar and drill cuttings can adhere as accretions to the metal surfaces of the drilling assembly, and metal surfaces in the wellbore such as liners and casing. Thus, the present method includes circulating the aqueous-based drilling fluid, as described above, while operating a drilling assembly to drill the wellbore.

In another aspect of the present invention the accretion additive and aqueous-based drilling fluid comprising said accretions additive may be used to remove existing accretions on metal surfaces as by circulation through a wellbore or washing of the wellbore surface systems. The removal of accretions may require washing over a period of time to remove a desired amount of the accretins.

The aqueous-based drilling fluid may be reused repeatedly by simply removing drill cuttings it contains.

It will be appreciated that a drilling assembly can include, for example, a drill bit and possibly other cutting surfaces, a drill string, wellbore liners, casings, and various control and monitoring subs.

It will also be appreciated, that it may not be necessary to use the same drilling mud throughout an entire drilling operation. For example, a drilling mud selected to control accretion may not be required during drilling through the over burden. The method using the aqueous-based drilling fluid of the present invention is particularly useful during drilling wherein oil sand drill cuttings are being produced and very useful where there is more frequent contact between metal surfaces or metal surfaces and the wellbore wall such as, for example, during drilling of the build section and the horizontal section of a wellbore.

Where, during drilling using an aqueous-based drilling fluid according to the present invention, accretions are being deposited to an undesirable extent, the composition can be adjusted to, for example, increase one or more additional additive, to inhibit further undesirable amounts of accretion and possibly to remove, at least to some degree, those accretions already deposited.

### EXAMPLES

### Evaluation of Accretion of Additives to Bitumen on Metal Surface

A description of the raw materials used in Examples 1 to 3 and Comparative Example A is as follows.
A-AA-1 is an anti-accretion additive comprising 22 weight percent C₈H₁₆O—(PO)₅ and 78 weight percent C₈H₁₆O—(PO)₅-(EO)₈;
A-AA-2 is an anti-accretion additive comprising 13 weight percent C₈H₁₆O—(PO)₅ and 87 weight percent C₈H₁₆O—(PO)₅-(EO)₁₀
Xanthan gum available from Aldrich;
Bitumen batch #5 product is obtained from Syncrude/Canmet;
Metal Coupon is a zinc plated mending brace measuring 76 mm×15 mm available from Lowe's manufactured by Stanley (5839-142/DPB118).

Into 200 grams of 0.4 percent xanthan gum aqueous solution in a 500 ml round bottom flask, 30 grams of bitumen is added. The flask is capped with a glass stopper and then vigorously shaken by hands for 3 to 5 minutes to break the bitumen ball and make the bitumen dispersed in the solution. The anti-additives are added after the shaking. After the addition of additives, the flask is rotated on rotary evaporator at 120 rpm for 30 minutes to get the additives dissolved. The metal coupon is washed with acetone and water, dried in air at room temperature, and is carefully placed into the flask. The flask containing the metal coupon is fixed onto a rotary evaporator and rotated at 20 rpm at room temperature for 60 minutes. The flask is then removed from the rotary evaporator and the metal coupon is carefully taken out from the flask using a Teflon coated magnetic retriever. The metal coupon is placed in a 50 ml VRW hexagonal polystyrene weighing dish in a way that one end of the flat coupon touches a bottom side of the dish and the opposite up side edge of the dish supports the coupon plate near the other end. This made the coupon to rest in the dish in about 30 degree angle. The coupon in the weighing dish is allowed to steadily stay in a fume hood at ambient condition for 2 hours to drain off the loosely adhered solution and bitumen. A picture is taken for the coupon from the side that had more adhered bitumen. The percentage of bitumen-covered area is estimated. The compositions of Examples 1 to 3 and Comparative Example A are shown in Table 1

TABLE 1

| | Com | | | |
|---|---|---|---|---|
| | Ex A | Ex 1 | Ex 2 | Ex 3 |
| A-AA-1, g | | 1 | | 0.5 |
| A-AA-2, g | | | 1 | |
| 0.4% Xanthan gum aqueous solution, g | 200 | 200 | 200 | 200 |
| Bitumen, g | 30 | 30 | 30 | 30 |

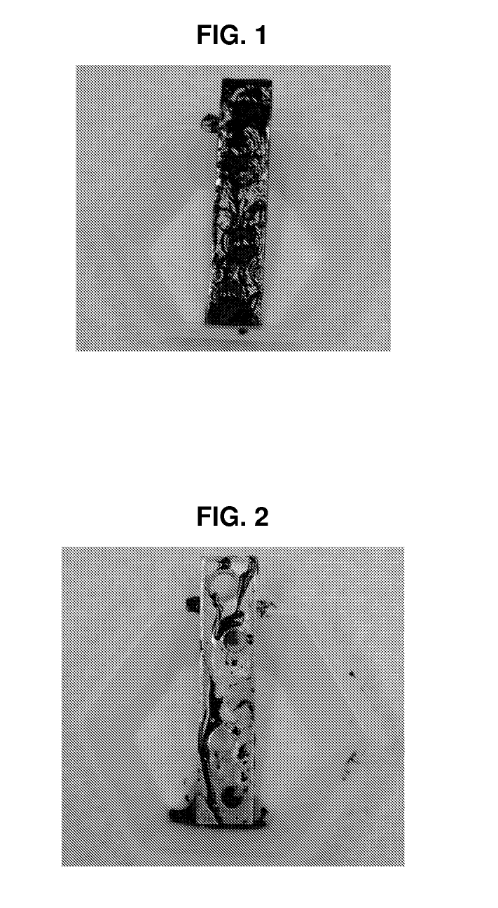

FIG. 1 is a picture of Comparative Example A. As seen, the metal coupon surface is almost completely covered by a thick bitumen layer.

FIG. 2 is a picture of Example 1. As seen, most of the metal coupon surface is free of bitumen residue.

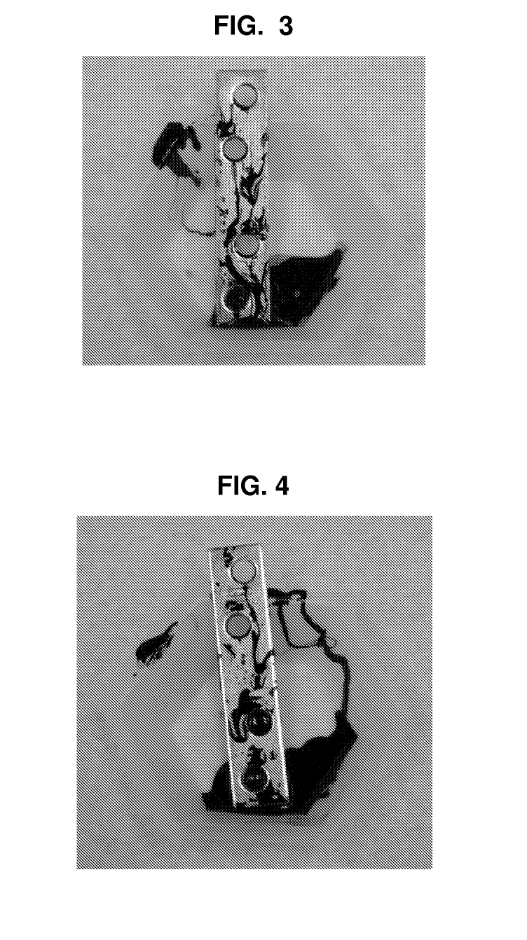

FIG. 3 is a picture of Example 2. As seen, most of the metal coupon surface is free of bitumen residue.

FIG. 4 is a picture of Example 3. As seen, most of the metal coupon surface is free of bitumen residue.

### Biodegradability

A-AA-1 and A-AA-2 are readily biodegradable (>60% in 28 days) according to OECD 301F.

### Aquatic Toxisity

The aquatic toxicity is 10-100 mg/l as measured according to OECD Guidelines 202, Daphnia sp. Acute Immobilization Test.

The Aquatic Toxicity and Biodegradation data compliant with CLEANGREDIENTS™ requirements

Oil Wash-Out from Tar Sands by Different Anti-Accretion Agents

A description of the raw materials used in Example 4 and Comparative Examples B to D is as follows.
Ethoxylated 2-propylheptnaol is available as LUTENSOL™ XP-70 from BASF;
Ethoxylated 2, 6, 8-trimethyl-4-nonanol is available as TERGITOL™ TMN-6 from The Dow Chemical Company;
Ethoxylated C₁₂-C₁₄ secondary alcohols is available as TERGITOL 15-S-7 from The Dow Chemical Company; and
Tar Sand is obtained from an oilfield in Alberta, Canada.

Into a 120 ml round wide-mouth glass bottle, 0.5 g of anti-accretion agent is weighed and then it is added with 99.5 g of water. A ¾ inch Teflon-coated stirring bar is put into the bottle and the solution was stirred for 2 hours to ensure the additive is completely dissolved. 5.0 grams of tar sand is added to the solution and the bottle is capped. All the samples are prepared in the same way and placed on the multi-position magnetic stirrer to stir at 500 rpm for 6 hours at room temperature. The stirrer is turned off and the samples are left undisturbed on the plate at room temperature for 2 days. Pictures are taken and the amount of oil on the surface edge is visually compared and subjectively ranked: 1=no oil appeared on the surface edge; 2=discontinuous oil dots on the surface edge; 3=continuous oil dots on the surface edge; 4=tick oil line on the surface edge; and 5=broad oil band on the bottle wall at the surface edge.

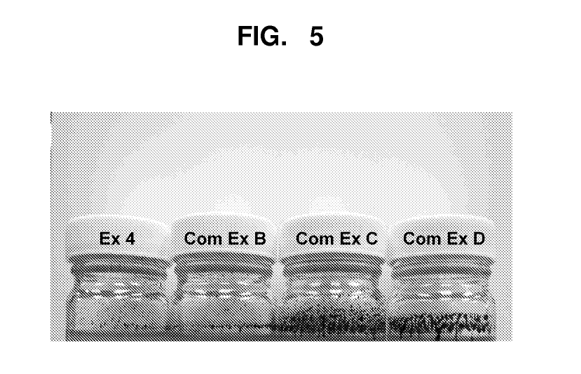

A-AA-1, LUTENSOL XP-70, TERGITOL TMN-6, and TERGITOL 15-S-7 all have a cloud point between 30° C. to 40° C. in 1 weight percent de-ionized water solution. FIG. 5 shows the amount of oil on the surface edge. As seen, Example 4 has the least amount of oil on the surface edge, followed by the sample with Comparative Example B. Significantly more oil is observed on the surface edge of the solution in the bottle for both Comparative Examples C and D. The results demonstrate that the anti-accretion agent of the present invention washes off less oil from tar sands compared to known surfactant based anti-accretion agents. This is useful to ease the removal of cuttings on the ground and minimize the damage to the wellborn.

TABLE 2

| | | Com | Com | Com |
|---|---|---|---|---|
| | Ex 4 | Ex B | Ex C | Ex D |
| A-AA-1, g | 0.5 | | | |
| Ethoxylated 2-propylheptnaol, g | | 0.5 | | |
| Ethoxylated 2, 6, 8-trimethyl-4-nonanol, g | | | 0.5 | |
| Ethoxylated C₁₂-C₁₄ secondary alcohols, g | | | | 0.5 |
| De-ionized water, g | 99.5 | 99.5 | 99.5 | 99.5 |
| Tar Sand, g | 5 | 5 | 5 | 5 |
| Surface Oil Amount Ranking | 2 | 3 | 5 | 5 |

what is claimed is:

1. An anti-accretion additive comprising:
i from 5 to 50 parts by weight of a propoxylated alcohol of the formula:
RO—(PO)ₓ
wherein
R is a linear or branched alkyl having from 8 to 16 carbons,
and
x is from 1 to 10,
and
ii from 95 to 50 parts by weight of a propoxylated and ethoxylated alcohol of the formula:
R¹O—(PO)_{y}-(EO)_{z},
wherein
R¹ is a linear or branched alkyl having from 8 to 16 carbons,
y is from 2 to 10,
and
z is from 3 to 20,
wherein parts by weight is based on the combined weight of the propoxylated alcohol i and a propoxylated and ethoxylated alcohol ii and EO and PO denote ethylene oxide and propylene oxide units, respectively.

2. The anti-accretion additive of claim 1 wherein R and R¹ are independently C₈-C₁₀ linear or branched alkyl.

3. The anti-accretion additive of claim 1 wherein R and R¹ are independently 2-ethylhexyl or 2-propylheptyl and x and y are 5, and z is from 5 to 10.

4. An aqueous-based drilling fluid comprising the anti-accretion additive of claim 1 and optionally a viscosifier.

5. The aqueous-based drilling fluid of claim 4 further comprising one or more of a fluid loss additive, a lubricant, a foam control agent, a weighting material, a salt, or a surfactant.

6. A method for drilling a wellbore through a formation comprising the steps of:
a operating a drilling assembly to drill a wellbore;
and
b circulating an aqueous-based drilling fluid through the wellbore as it is drilled, the aqueous-based drilling fluid comprising an anti-accretion additive comprising:
i from 5 to 50 parts by weight of a propoxylated alcohol of the formula:
RO—(PO)ₓ
wherein
R is a linear or branched alkyl having from 8 to 16 carbons,
and
x is from 1 to 10,
and
ii from 95 to 50 parts by weight of a propoxylated and ethoxylated alcohol of the formula:
R¹O—(PO)_{y}-(EO)_{z},
wherein
R¹ is a linear or branched alkyl having from 8 to 16 carbons,
y is from 2 to 10,
and
z is from 3 to 20,
wherein parts by weight is based on the combined weight of the propoxylated alcohol i and a propoxylated and ethoxylated alcohol ii and EO and PO denote ethylene oxide and propylene oxide units, respectively.

7. A method for limiting accretion on metal surfaces in contact with tar-sand containing formation, the method comprising the step of washing the metal surfaces with an aqueous-based drilling fluid comprising an anti-asccretion additive comprising:
i from 5 to 50 parts by weight of a propoxylated alcohol of the formula:
RO—(PO)ₓ
wherein
R is a linear or branched alkyl having from 8 to 16 carbons,
and
x is from 1 to 10,
and
ii from 5 to 50 parts by weight of a propoxylated alcohol of the formula:
R¹O—(PO)_{y}-(EO)_{z},
wherein
R¹ is a linear or branched alkyl having from 8 to 16 carbons,
y is from 2 to 10,
and
z is from 3 to 20,
wherein parts by weight is based on the combined weight of the propoxylated alcohol i and a propoxylated and ethoxylated alcohol ii and EO and PO denote ethylene oxide and propylene oxide units, respectively.

8. A method for removing accretion from metal surfaces in contact with tar sand-containing formation comprising the step of washing the metal surfaces with an aqueous-based drilling fluid comprising an anti-asccretion additive comprising:
i from 5 to 50 parts by weight of a propoxylated alcohol of the formula:
RO—(PO)ₓ
wherein
R is a linear or branched alkyl having from 8 to 16 carbons,
and
x is from 1 to 10,
and
ii from 95 to 50 parts by weight of a propoxylated and ethoxylated alcohol of the formula:
R¹O—(PO)_{y}-(EO)_{z},
wherein
R¹ is a linear or branched alkyl having from 8 to 16 carbons,
y is from 2 to 10,
and
z is from 3 to 20,
wherein parts by weight is based on the combined weight of the propoxylated alcohol i and a propoxylated and ethoxylated alcohol ii and EO and PO denote ethylene oxide and propylene oxide units, respectively.
